(19) United States
(12) Patent Application Publication
(10) Pub. No.: US 2026/0277177 A1
(43) Pub. Date: Sep. 17, 2026

(54) MACHINING INFORMATION DISPLAY DEVICE

(71) Applicant: FANUC CORPORATION, Yamanashi (JP)

(72) Inventors: Daisuke UENISHI, Yamanashi (JP); Yasuaki KOYAMA, Yamanashi (JP); Takahiro ENDOU, Yamanashi (JP); Yasuyuki YAMAMOTO, Yamanashi (JP)

(73) Assignee: FANUC CORPORATION, Yamanashi (JP)

(21) Appl. No.: 19/474,510

(22) PCT Filed: May 9, 2023
(86) PCT No.: PCT/JP2023/017481

§ 371 Date: Oct. 10, 2025

(51) Int. Cl. G05B 19/042

(52) U.S. Cl. CPC G05B 19/042; G05B 2219/2206

(57) ABSTRACT

The present invention provides a machining information display device enabling a user, regardless of their skill level, to easily select a machining mode of a machine tool and perform efficient machining. This machining information display device has at least two machining modes defining a combination of parameters for at least one from among an acceleration/deceleration function, a servo function, and a correction function required for machining by a machine tool, and includes a display control unit that displays, on a display device, information on the machining modes. The machining modes are classified into one or more machining types according to machining. The display control unit displays one or more machining type images for selection from among the one or more machining types, and when one machining type is selected from among the one or more machining types, displays an image indicating a machining mode set for the machining type.

### TECHNICAL FIELD

The present disclosure relates to a machining information display device.

### BACKGROUND ART

Conventionally, operating a machine tool to machine a workpiece sometimes involves setting optimal acceleration/deceleration parameters depending on a machining object or a machining method employed. For milling workpieces such as automotive parts, where contour accuracy is not required, acceleration/deceleration parameters that allow for high speed operation are needed. By contrast, for mold machining such as electrode machining, where contour accuracy is required, acceleration/deceleration parameters that allow for high contour accuracy are needed.

As such, efficient machining has conventionally been achieved by changing acceleration/deceleration parameters as appropriate to suit the machining object or the machining method. However, changing parameters depending on the machining object requires the expertise of a skilled operator well-versed in both machining with a machine tool and operating a numerical control device.

Taking such circumstances into account, a conventional numerical control device is equipped with a machining mode setting function, storing combinations of acceleration/deceleration parameters predefined based on motion characteristics of a machine tool. Thus, the numerical control device allows even a non-skilled user to collectively change acceleration/deceleration parameters on a per machining object basis by selecting a pattern as appropriate on a screen of a display device of the numerical control device or by issuing an M-code command. Such a technique is disclosed, for example, in Patent Document 1.

### CITATION LIST

### Patent Document

Patent Document 1: Japanese Unexamined Patent Application, Publication No. 2002-172543

### DISCLOSURE OF THE INVENTION

### Problems to be Solved by the Invention

There is a demand for a technique that makes it possible to easily select a machining mode for a machine tool regardless of the user's skill level, thereby facilitating efficient machining.

### Means for Solving the Problems

An aspect of the present disclosure is directed to a machining information display device having at least two machining modes each defining a combination of parameters of at least one of an acceleration/deceleration function, a servo function, or a compensation function required for machining with a machine tool, the machining information display device including a display control unit that displays information pertaining to the machining modes on a display device, wherein the machining modes are classified into one or more machining types based on machining, and the display control unit displays one or more machining type images that are used to select one of the one or more machining types, and upon one of the one or more machining types being selected, displays an image showing any of the machining modes set for the selected machining type.

### BRIEF DESCRIPTION OF THE DRAWINGS

FIG. 1 is a block diagram illustrating a configuration of a numerical control device, which serves as a machining information display device according to an embodiment of the present disclosure;

FIG. 2 is a diagram illustrating a display screen related to machining types according to the present embodiment;

FIG. 3 is a diagram for describing machining types;

FIG. 4 is a diagram for describing a machining type image;

FIG. 5 is a diagram for describing a machining type image;

FIG. 6 is a table showing examples of colors assigned to machining type images;

FIG. 7 is a diagram showing examples of names of machining modes;

FIG. 8 is a diagram showing examples of names of machining modes;

FIG. 9 illustrates a display screen as an example of a description of a machining type or a machining mode;

FIG. 10 illustrates a display screen as an example of a detailed description of the machining types or the machining modes;

FIG. 11 shows an example of a machining type image in which a certain machining type is hidden;

FIG. 12 shows an example of a machining type image in which the certain machining type is displayed;

FIG. 13 shows an example of a list of parameters;

FIG. 14 shows an example of a comparison table of parameters;

FIG. 15 shows an example of a chart related to parameters;

FIG. 16 shows an example of a chart related to parameters;

FIG. 17 shows an example of a chart related to parameters;

FIG. 18 shows examples of machining type images and lists of machining modes;

FIG. 19 shows an example of a sorting function;

FIG. 20 shows an example of a list of machining modes sorted using the sorting function;

FIG. 21 shows an example of a machining type image; and

FIG. 22 shows an example of a machining type image.

### PREFERRED MODE FOR CARRYING OUT THE INVENTION

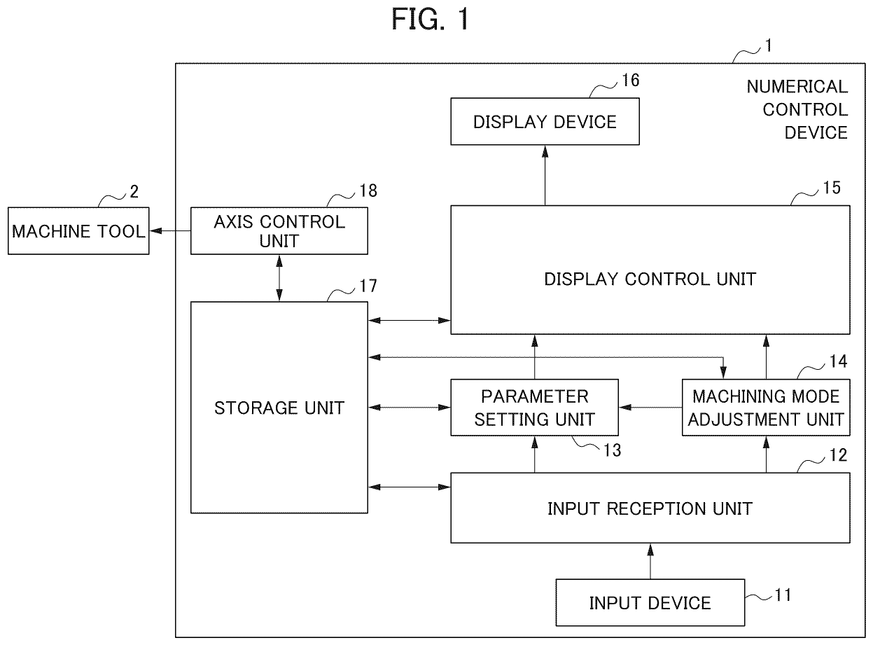

The following describes an example of an embodiment of the present disclosure. FIG. 1 is a block diagram illustrating a configuration of a numerical control device 1, which serves as a machining information display device according to an embodiment of the present disclosure.

The machining information display device displays information pertaining to machining of a workpiece with a tool. The machining information display device may be implemented by causing one or more computer devices having memory, a processor, an input/output interface, and the like to execute an appropriate control program. Specific examples of machining information display devices other than the numerical control device 1 that controls a machine tool 2 described below include devices obtained by adding functions described below to a machining simulator that simulates the operation of a machine tool or a management computer that manages a plurality of machine tools.

The numerical control device 1 is used to control the machine tool 2, and thus cause the machine tool 2 to perform a predetermined machining or other operation. Note here that the machine tool 2 may be, for example, a machining center having a plurality of drive axes.

The numerical control device 1 includes an input device 11, an input reception unit 12, a parameter setting unit 13, a machining mode adjustment unit 14, a display control unit 15, a display device 16, a storage unit 17, and an axis control unit 18.

The input reception unit 12, the parameter setting unit 13, the machining mode adjustment unit 14, the display control unit 15, and the axis control unit 18 are functions that are implemented by a controller of the numerical control device 1. In other words, the controller includes one or more processors, such as a central processing unit (CPU), and implements these functions by executing a program stored in the storage unit 17.

The storage unit 17 includes storage devices such as read only memory (ROM), random access memory (RAM), a hard disk drive (HDD), and a solid state drive (SSD), and stores various types of information therein. In the present embodiment, the storage unit 17 is provided in the numerical control device 1. Alternatively, the storage unit 17 may be provided in an electronic device or a server external to the numerical control device 1.

The display device 16 displays various types of information based on signals transmitted from the display control unit 15. The display device 16 includes, for example, a liquid crystal display (LCD), an organic electroluminescent (EL) display, or a cathode-ray tube (CRT) display. In the present embodiment, the display device 16 is provided in the numerical control device 1. Alternatively, the display device 16 may be, for example, an external electronic device or an external display device that is connected to the numerical control device 1.

The input device 11 includes, for example, buttons, keys, switches, a keyboard, a mouse, and a teach pendant, and receives various input operations from a user. It should be noted that the input device 11 and the display device 16 may be a teach pendant having an integrated touch panel or the like. The teach pendant may be implemented using a tablet terminal.

The input reception unit 12 receives input operations entered using the input device 11 and provides information corresponding to the input operations to the parameter setting unit 13, the machining mode adjustment unit 14, the display control unit 15, the axis control unit 18, and the storage unit 17. The parameter setting unit 13 calculates and sets parameters related to machining modes based on input operations received by the input reception unit 12 and various types of information stored in the storage unit 17.

The machining mode adjustment unit 14 adjusts settings related to the machining modes based on input operations received by the input reception unit 12 and various types of information stored in the storage unit 17. The display control unit 15 displays information pertaining to the machining modes on the display device 16. The axis control unit 18 controls drive axes of the machine tool 2 such as a spindle and feed axes.

The numerical control device 1 according to the present embodiment has at least two machining modes each defining a combination of parameters of at least one of an acceleration/deceleration function, a servo function, or a compensation function required for machining with the machine tool 2, and the display control unit 15 displays information pertaining to the machining modes on the display device 16.

The machining modes are classified into one or more machining types based on machining. The display control unit 15 displays one or more machining type images that are used to select one of the one or more machining types, and upon one of the one or more machining types being selected, displays an image (radar chart) showing any of the machining modes set for the selected machining type.

The machining types include Parts, Shape/Mold, IT, and Four-axis or Five-axis. The image showing the machining mode is represented in one of the following display formats: a radar chart, a pie chart, a block-style gauge chart, and a map. Each machining mode defines a combination of parameters of at least one of the acceleration/deceleration function, the servo function, or the compensation function required for machining with the machine tool 2. Examples of machining modes include Standard, High-speed, Contour machining, and Low-vibration.

The acceleration/deceleration function refers to a function related to control for accelerating and decelerating drive axes such as the spindle and the feed axes or a function related to control of overlap, tap retraction speed, and the like. The servo function refers to a function related to servo motor control. For example, gains that improve the tracking performance of motors in response to commands fall under the servo function. The compensation function refers to a function related to control for compensation or correction of machining program, TCP, and the like.

Indicators related to the machining are used as references for judging or evaluating the machining with the machine tool 2. Examples of such indicators include Cycle time reduction, Vibration suppression, Overlap, Smoothness, Accuracy, Tapping speed, Program correction, Cutter mark compensation, and Tool center point (TCP) control function.

The machining modes are classified into machining types based on machining. Note here that the machining types refer to types of the combinations of parameters of at least one of the acceleration/deceleration function, the servo function, or the compensation function depending on the machining object. The machining types include, for example, Parts, Shape/Mold, IT, and Four-axis or Five-axis. The display control unit 15 displays, on the display device 16, the machining modes on a per machining type basis.

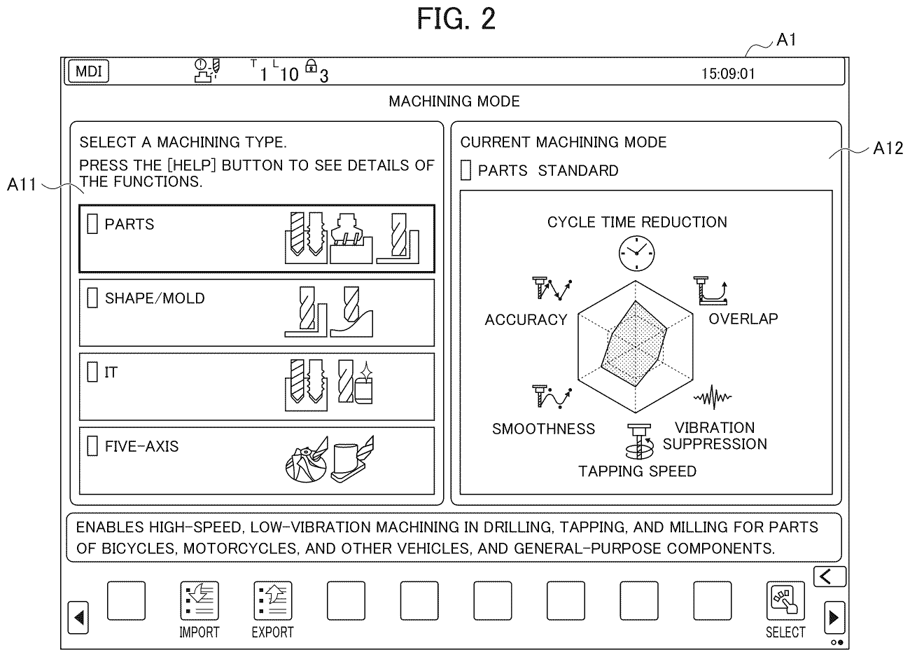

FIG. 2 is a diagram illustrating a display screen A1 pertaining to machining types according to the present embodiment. As shown in FIG. 2, the display screen A1 includes an image A11 (machining type image) that is displayed on the left side of the screen and used to select one of the one or more machining types, and an image A12 that is displayed on the right side of the screen and shows characteristics of a machining mode using a radar chart. The display screen A1 also includes an image that is displayed on the lower side of the screen and used to select various functions.

More specifically, the image A11 shows Parts, Shape/Mold, IT, and Five-axis as machining types. In the example shown in FIG. 2, a cursor operated through the input device 11 is selecting the machining type “Parts”.

Likewise, any of the other machining types “Shape/Mold”, “IT”, and “Five-axis” can be selected using the cursor operated through the input device 11. Furthermore, the image A11 includes icons that show examples of states in machining for the respective machining types “Parts”, “Shape/Mold”, “IT”, and “Five-axis”.

The image A12 shows a radar chart corresponding to a case where the cursor operated through the input device 11 is selecting the machining type “Parts” and the machining mode is “Standard”. The radar chart shown in the image A12 shows a score for each of the indicators, Cycle time reduction, Overlap, Vibration suppression, Tapping speed, Smoothness, and Accuracy.

Furthermore, the display control unit 15 displays icons related to the respective indicators and names of the respective indicators at vertices of the radar chart in the image A12.

It should be noted that the machining types and the machining modes described above may be set, created, or added by the user as appropriate. For example, the machining mode adjustment unit 14 may set, create, or add a machining type or a machining mode as appropriate based on an input operation received by the input reception unit 12, and the display control unit 15 may display the set, created, or added machining type or machining mode on the display device 16.

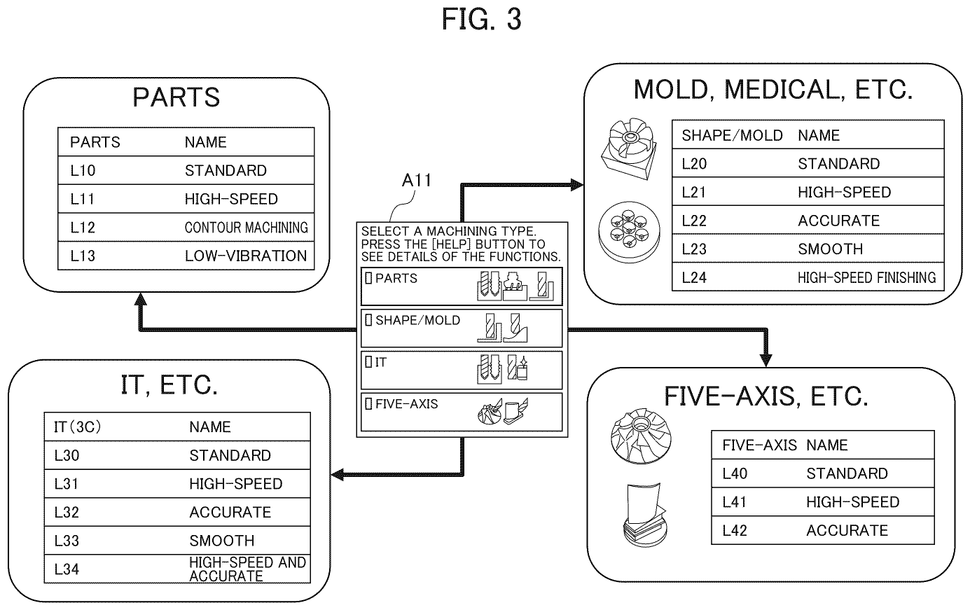

FIG. 3 is a diagram for describing the machining types. As shown in FIG. 3, the machining types are classified into Parts, Shape/Mold, IT, and Five-axis (or Four-axis, etc.). Each of the machining types has machining modes in which parameters of the acceleration/deceleration function, the servo function, and the compensation function suitable for the machining are set. Specifically, the machining type “Parts” has a machining mode “Standard” (Parts L10), a machining mode “High-speed” (Parts L11), a machining mode “Contour machining” (Parts L12), and a machining mode “Low-vibration” (Parts L13).

The machining type “Shape/Mold” has a machining mode “Standard” (Shape/Mold L20), a machining mode “High-speed” (Shape/Mold L21), a machining mode “Accurate” (Shape/Mold L22), a machining mode “Smooth” (Shape/Mold L23), and a machining mode “High-speed finishing” (Shape/Mold L24).

The machining type “IT” has a machining mode “Standard” (IT L30), a machining mode “High-speed” (IT L31), a machining mode “Accurate” (IT L32), a machining mode “Smooth” (IT L33), and a machining mode “High-speed and accurate” (IT L34).

The machining type “Five-axis” has a machining mode “Standard” (Five-axis L40), a machining mode “High-speed” (Five-axis L41), and a machining mode “Accurate” (Five-axis L42).

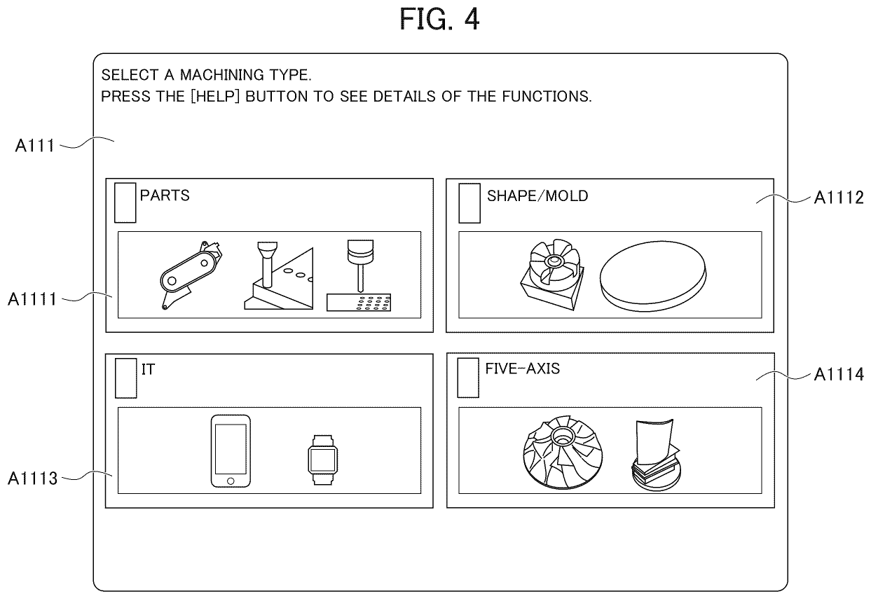

The one or more machining type images may include a photograph of a machined product or a graphic related to a machining method employed. FIG. 4 is a diagram for describing a machining type image. A machining type image A111 shown in FIG. 4 includes an image A1111 that shows the machining type “Parts”, an image A1112 that shows the machining type “Shape/Mold”, an image A1113 that shows the machining type “IT”, and an image A1114 that shows the machining type “Five-axis”.

The images A1111 to A1114 each include a photograph of a machined product corresponding to the machining type. Alternatively, the images A1111 to A1114 may include a graphic (for example, an icon) related to a machining method instead of a photograph of a machined product.

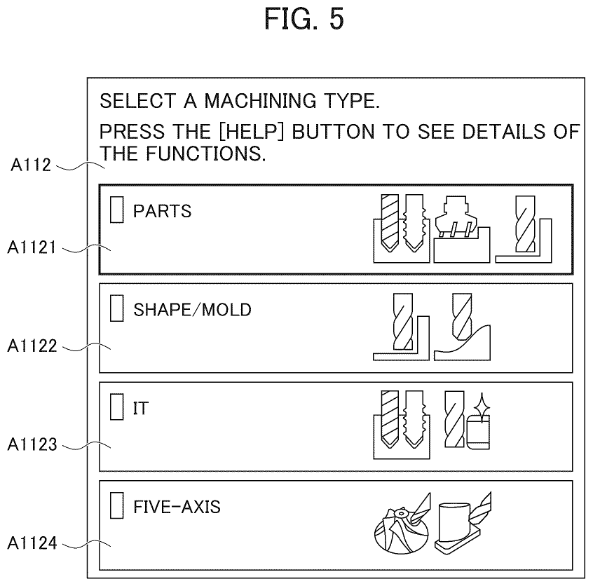

Alternatively, the machining type images may be assigned one or more of alphanumeric characters and/or symbols, icons, or colors for identifying the machining types. FIG. 5 is a diagram for describing a machining type image. A machining type image A112 shown in FIG. 5 includes an image A1121 that shows the machining type “Parts”, an image A1122 that shows the machining type “Shape/Mold”, an image A1123 that shows the machining type “IT”, and an image A1124 that shows the machining type “Five-axis”.

The images A1121 to A1124 each include a color, a name, and an icon for identifying the corresponding machining type. The images A1121 to A1124 may each be further assigned an alphanumeric character and/or a symbol for identifying the corresponding machining type. The alphanumeric character and/or the symbol may be, for example, used also in other display screens such as a screen for displaying a machining status.

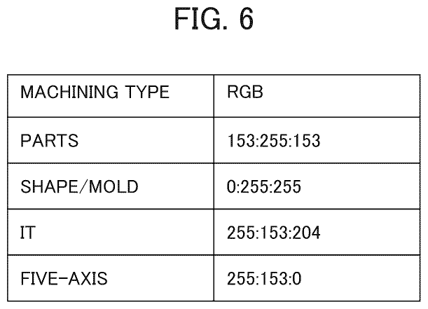

Preferably, the colors assigned for identifying the machining types are distinguishable by individuals with color vision deficiency. FIG. 6 is a table showing examples of colors assigned to the machining type images. For example, a machining type image in the case of the machining type “Parts” may be displayed in a color represented by an RGB ratio of 153:255:153. A machining type image in the case of the machining type “Shape/Mold” may be displayed in a color represented by an RGB ratio of 0:255:255. A machining type image in the case of the machining type “IT” may be displayed in a color represented by an RGB ratio of 255:153:204. A machining type image in the case of the machining type “Five-axis” may be displayed in a color represented by an RGB ratio of 255:153:0.

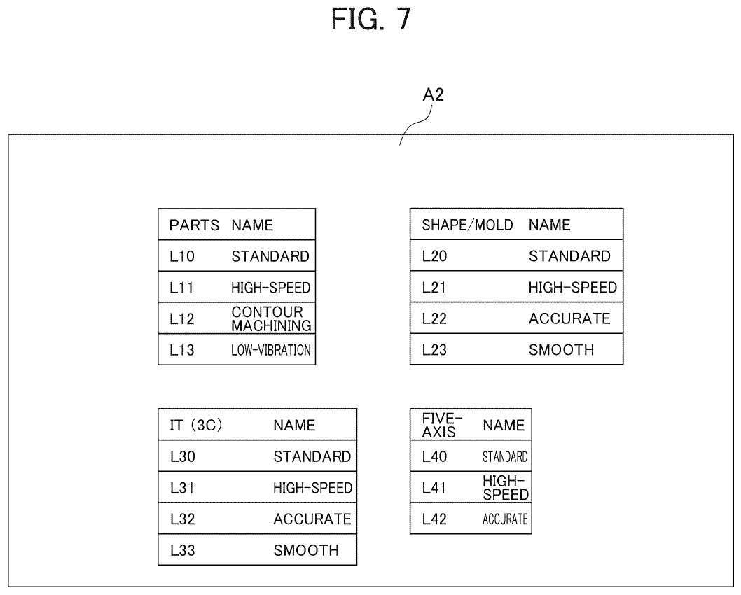

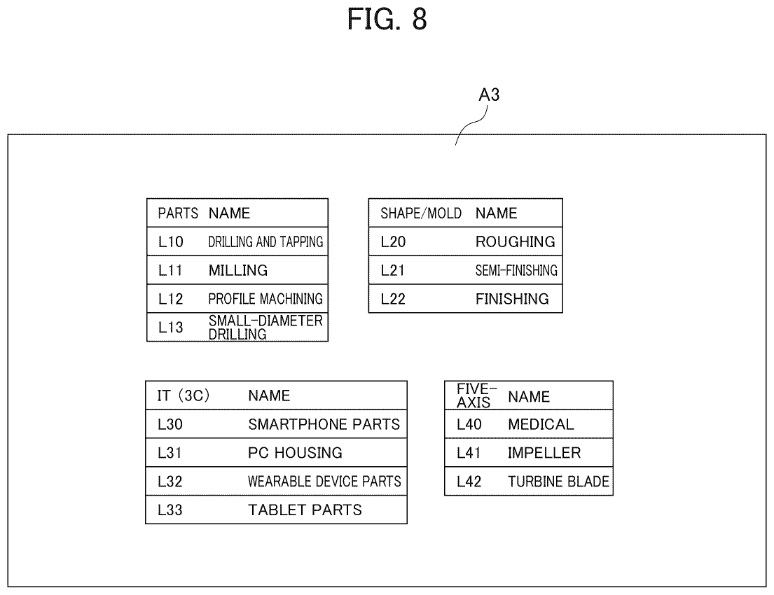

Preferably, the machining modes have names that are consistent across the different machining types. Preferably, the machining modes have names that indicate machining content. FIGS. 7 and 8 are diagrams each showing examples of names of the machining modes. A list A2 shown in FIG. 7 shows names of the machining modes that are consistent across the different machining types. Specifically, the machining type “Parts” has the machining mode “Standard” (Parts L10), the machining mode “High-speed” (Parts L11), the machining mode “Contour machining” (Parts L12), and the machining mode “Low-vibration” (Parts L13).

The machining type “Shape/Mold” has the machining mode “Standard” (Shape/Mold L20), the machining mode “High-speed” (Shape/Mold L21), the machining mode “Accurate” (Shape/Mold L22), and the machining mode “Smooth” (Shape/Mold L23).

The machining type “IT” has the machining mode “Standard” (IT L30), the machining mode “High-speed” (IT L31), the machining mode “Accurate” (IT L32), and the machining mode “Smooth” (IT L33).

The machining type “Five-axis” has the machining mode “Standard” (Five-axis L40), the machining mode “High-speed” (Five-axis L41), and the machining mode “Accurate” (Five-axis L42).

A list A3 shown in FIG. 8 shows names of the machining modes that indicate machining content. Specifically, the machining type “Parts” has a machining mode “Drilling and tapping” (Parts L10), a machining mode “Milling” (Parts L11), a machining mode “Profile machining” (Parts L12), and a machining mode “Small-diameter drilling” (Parts L13).

The machining type “Shape/Mold” has a machining mode “Roughing” (Shape/Mold L20), a machining mode “Semi-finishing” (Shape/Mold L21), and a machining mode “Finishing” (Shape/Mold L22).

The machining type “IT” has a machining mode “Smartphone parts” (IT L30), a machining mode “PC housing” (IT L31), a machining mode “Wearable device parts” (IT L32), and a machining mode “Tablet parts” (IT L33).

The machining type “Five-axis” has a machining mode “Medical” (Five-axis L40), a machining mode “Impeller” (Five-axis L41), and a machining mode “Turbine blade” (Five-axis L42).

Upon the input reception unit 12 receiving an input operation from the user, the display control unit 15 displays a brief description of the machining types or the machining modes, or a detailed description of the machining types or the machining modes, depending on the operation received from the user.

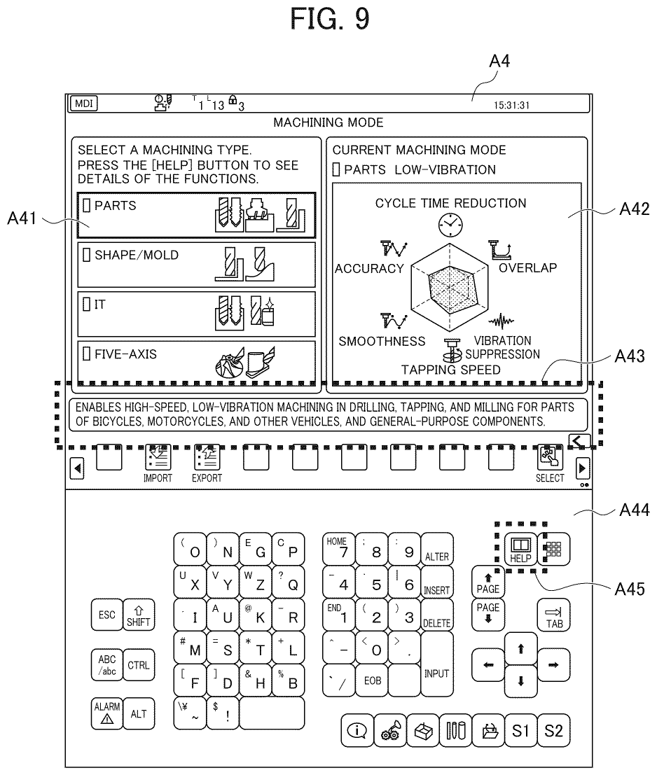

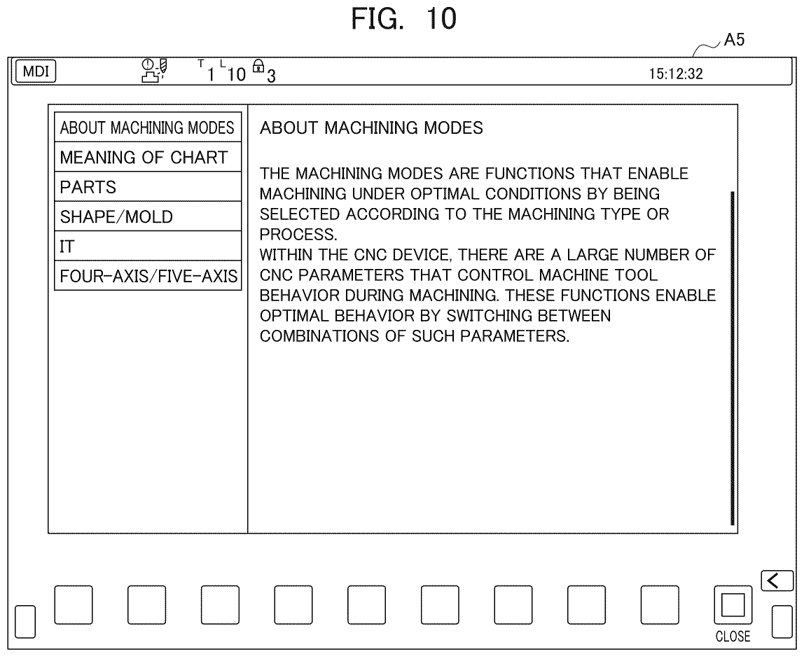

FIG. 9 illustrates a display screen A4 as an example of a description of a machining type or a machining mode. FIG. 10 illustrates a display screen A5 as an example of a detailed description of the machining types or the machining modes. The display screen A4 includes an image A41 (machining type image) that is used to select one of the one or more machining types, an image A42 that shows characteristics of a machining mode using a radar chart, an image A43 that shows a brief description of a machining type or a machining mode, an image A44 that shows a screen keyboard, and an image A45 that shows a help function on the screen keyboard. Upon the image A45 that shows the help function being selected through the user's operation, the display control unit 15 displays the display screen A5 that shows a detailed description of the machining modes as shown in FIG. 10.

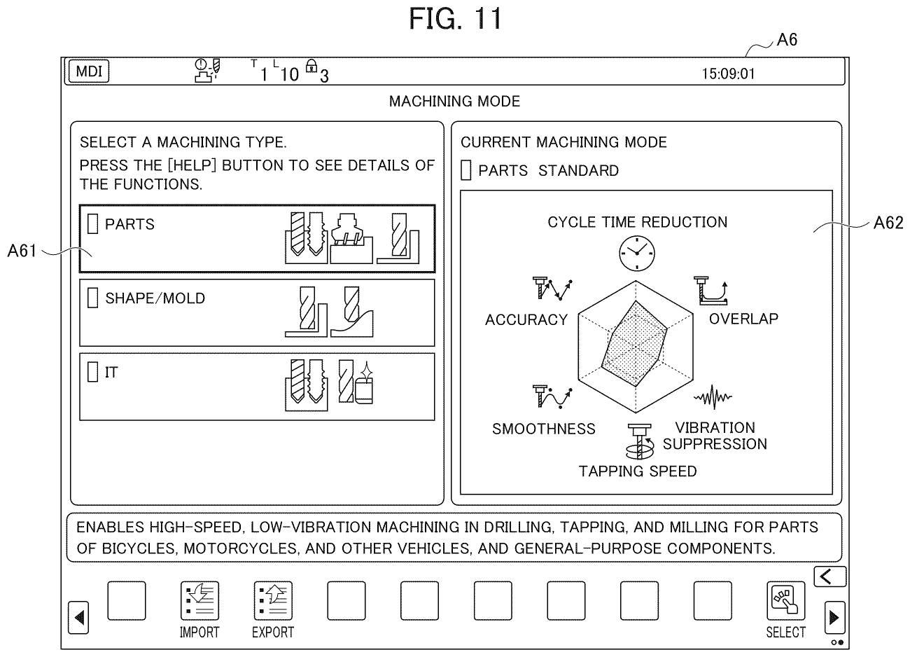

The display control unit 15 may switch between displaying and hiding images related to the machining types or the machining modes depending on the state of the machine tool 2. FIG. 11 shows an example of a machining type image in which a certain machining type is hidden. As shown in FIG. 11, in the case of the machining mode “Standard”, a display screen A6 includes an image A61 (machining type image) that is displayed on the left side of the screen and used to select one of the one or more machining types, and an image A62 that is displayed on the right side of the screen and shows characteristics of a machining mode using a radar chart.

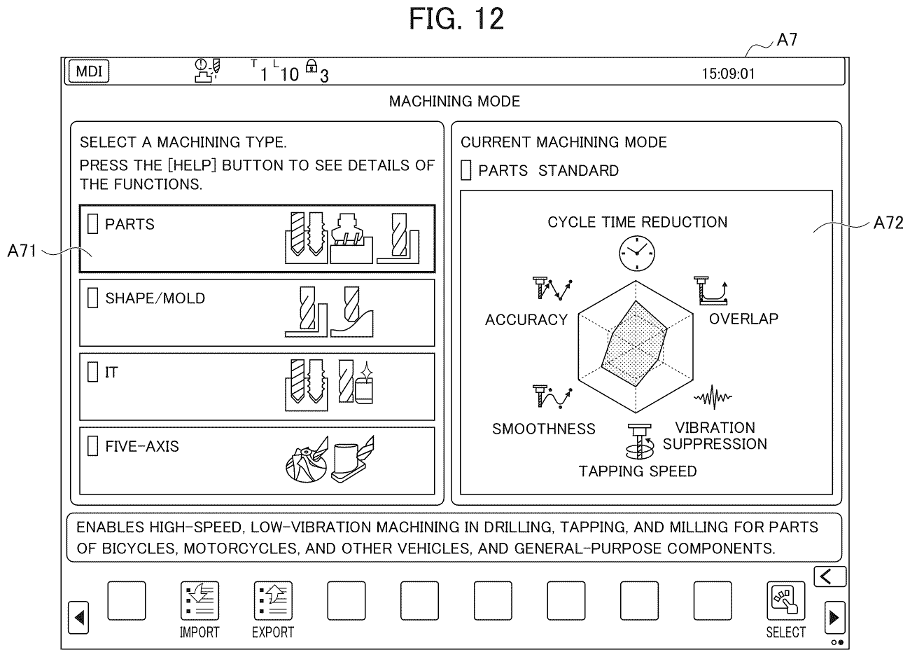

FIG. 12 shows an example of a machining type image in which the certain machining type is displayed. As shown in FIG. 12, a display screen A7 includes an image A71 (machining type image) that is displayed on the left side of the screen and used to select one of the one or more machining types, and an image A72 that is displayed on the right side of the screen and shows characteristics of a machining mode using a radar chart. As shown in FIGS. 11 and 12, the display control unit 15 switches between displaying and hiding the machining type “Five-axis” depending on whether or not a five-axis option of the machine tool 2 is available. This configuration allows the user to select a machining type without seeing unnecessary information.

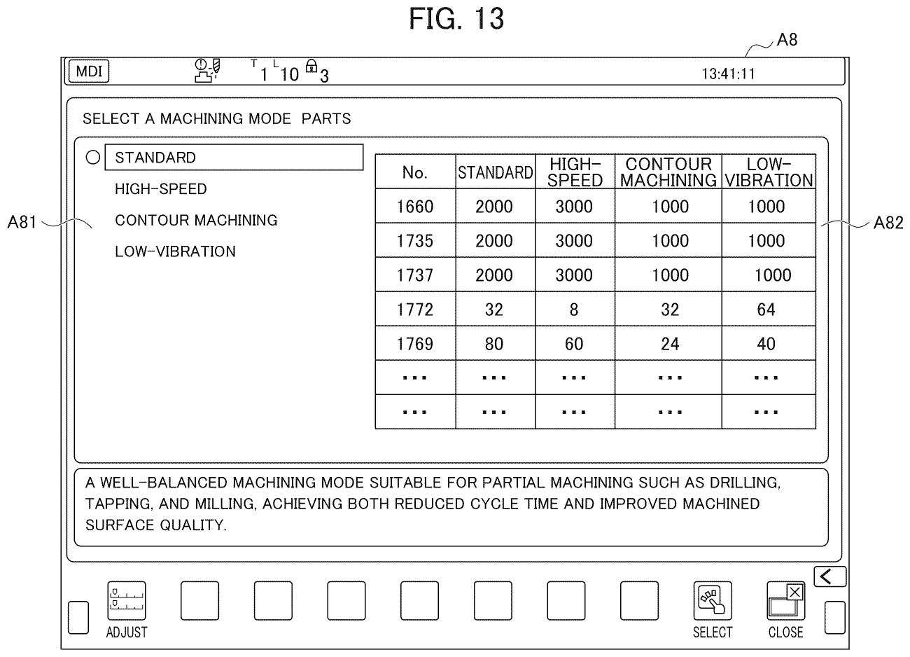

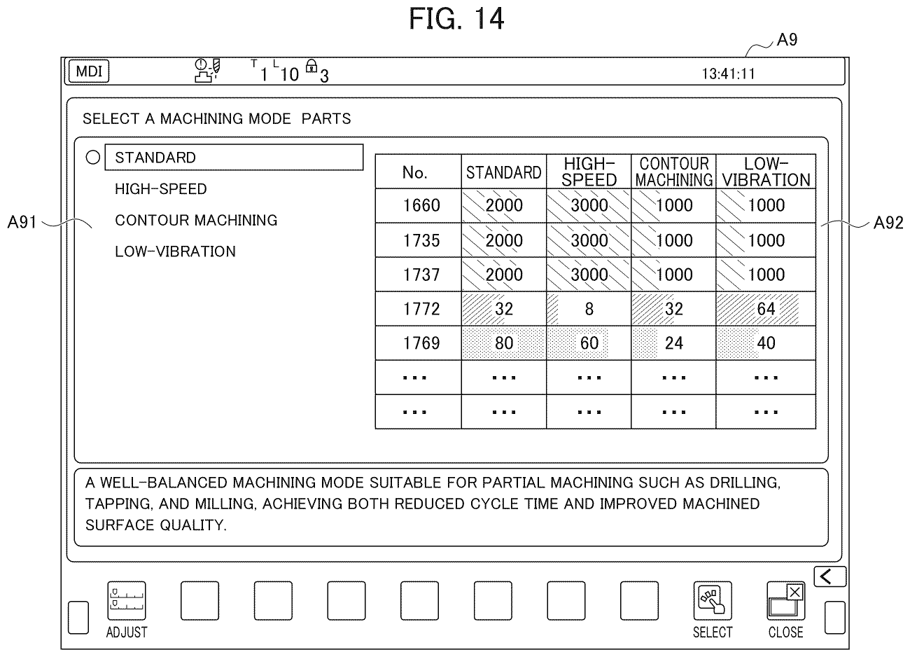

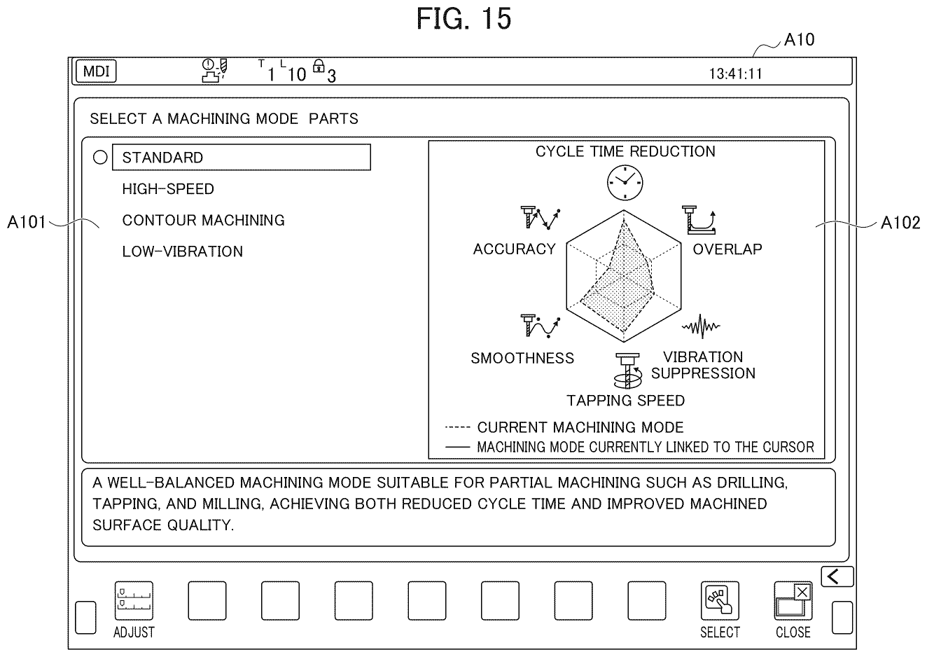

Furthermore, the display control unit 15 displays a list of parameters, a comparison table of parameters, or a chart related to parameters along with a list of the machining modes. FIG. 13 shows an example of a list of parameters. FIG. 14 shows an example of a comparison table of parameters. FIGS. 15 to 17 show examples of charts related to parameters. A display screen A8 shown in FIG. 13 includes an image A81 that is displayed on the left side of the screen and shows a list of machining modes, and an image A82 that is displayed on the right side of the screen and shows a list of varying parameters of the machining modes.

The image A82 shown in FIG. 13 shows numbers assigned to the parameters (for example, 1660), values of the parameters (for example, 2000) in the currently selected machining mode “Standard”, values of the parameters (for example, 3000) in the machining mode “High-speed”, values of the parameters (for example, 1000) in the machining mode “Contour machining”, and values of the parameters (for example, 1000) in the machining mode “Low-vibration”.

A display screen A9 shown in FIG. 14 includes an image A91 that is displayed on the left side of the screen and shows a list of machining modes, and an image A92 that is displayed on the right side of the screen and shows a list of varying parameters of the machining modes and a comparison table of the parameters.

The image A92 shown in FIG. 14 shows numbers assigned to the parameters and values of the parameters as in the case of the image A82 shown in FIG. 13, and further shows a bar chart for comparison of each parameter.

A display screen A10 shown in FIG. 15 includes an image A101 that is displayed on the left side of the screen and shows the currently selected machining mode, and an image A102 that is displayed on the right side of the screen and shows characteristics of the machining mode using a radar chart.

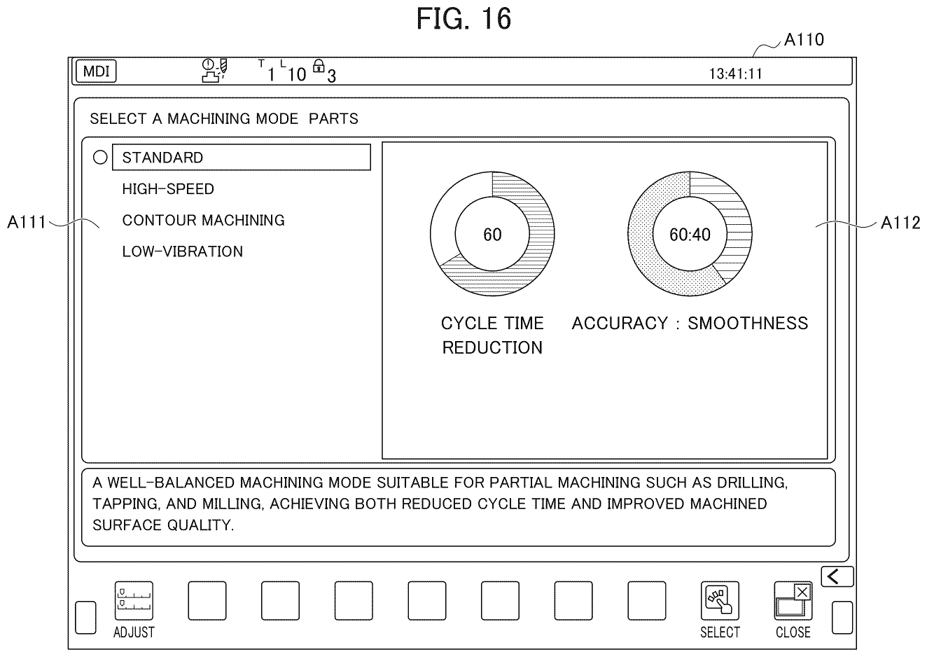

A display screen A110 shown in FIG. 16 includes an image A111 that is displayed on the left side of the screen and shows the currently selected machining mode, and an image A112 that is displayed on the right side of the screen and shows characteristics of the machining mode using pie charts.

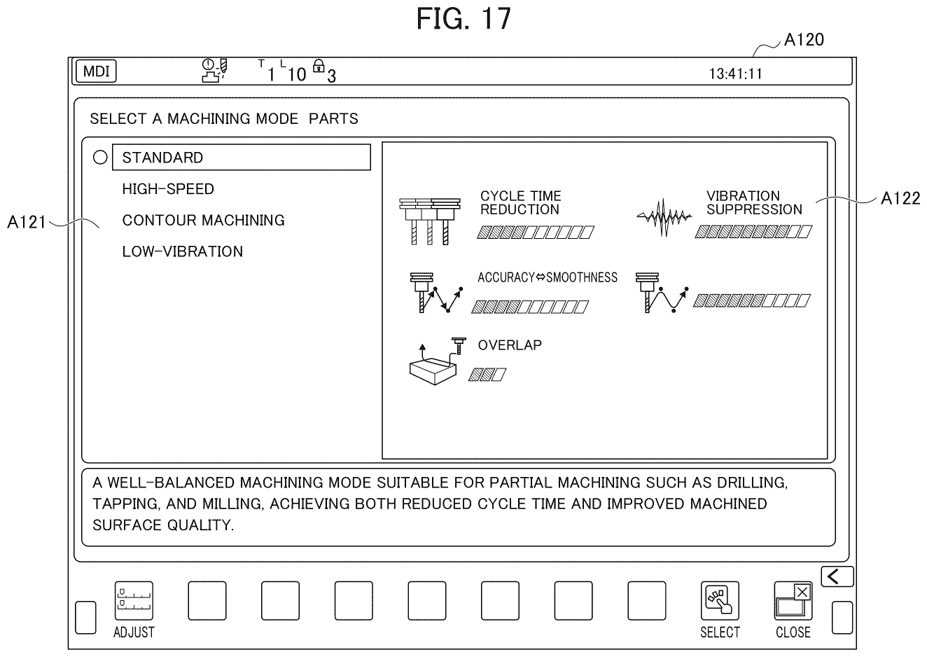

A display screen A120 shown in FIG. 17 includes an image A121 that is displayed on the left side of the screen and shows the currently selected machining mode, and an image A122 that is displayed on the right side of the screen and shows characteristics of the machining mode using block-style gauge charts.

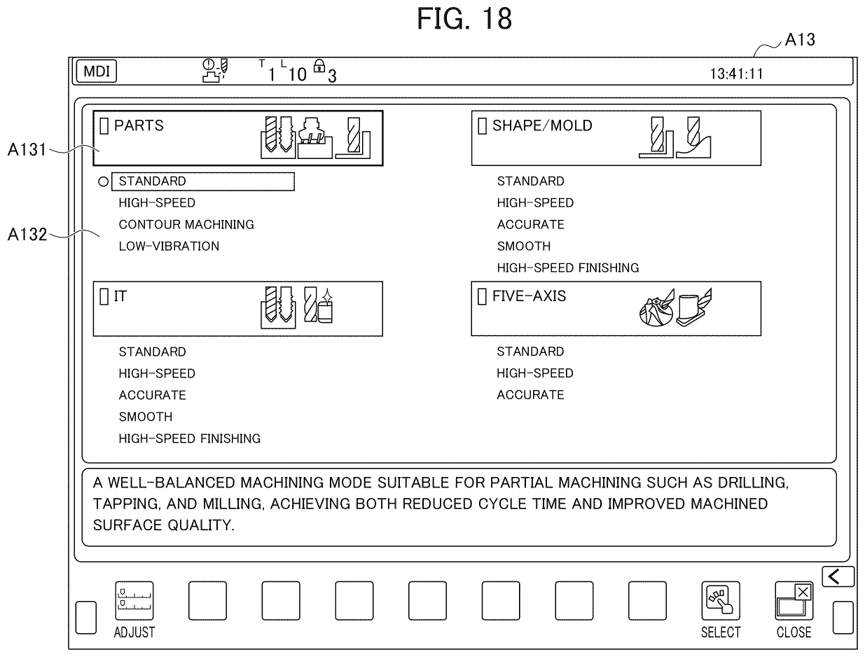

Furthermore, the display control unit 15 may display machining type images and lists of machining modes on the same screen. FIG. 18 shows examples of machining type images and lists of machining modes. A display screen A13 shown in FIG. 18 includes a machining type image A131 and an image A132 that shows a list of machining modes. Specifically, the display control unit 15 displays the machining type image A131 that shows the machining type “Parts” and the image A132 that shows a list of machining modes corresponding to the machining type “Parts”.

The display control unit 15 also displays a machining type image that shows the machining type “Shape/Mold” and an image that shows a list of machining modes corresponding to the machining type “Shape/Mold”, a machining type image that shows the machining type “IT” and an image that shows a list of machining modes corresponding to the machining type “IT”, and a machining type image that shows the machining type “Five-axis” and an image that shows a list of machining modes corresponding to the machining type “Five-axis”.

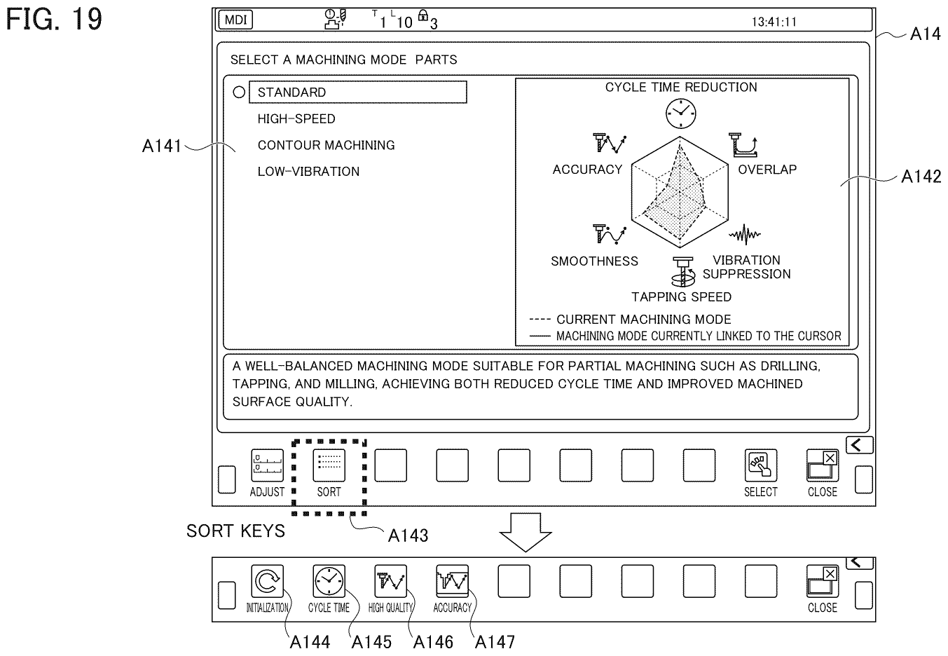

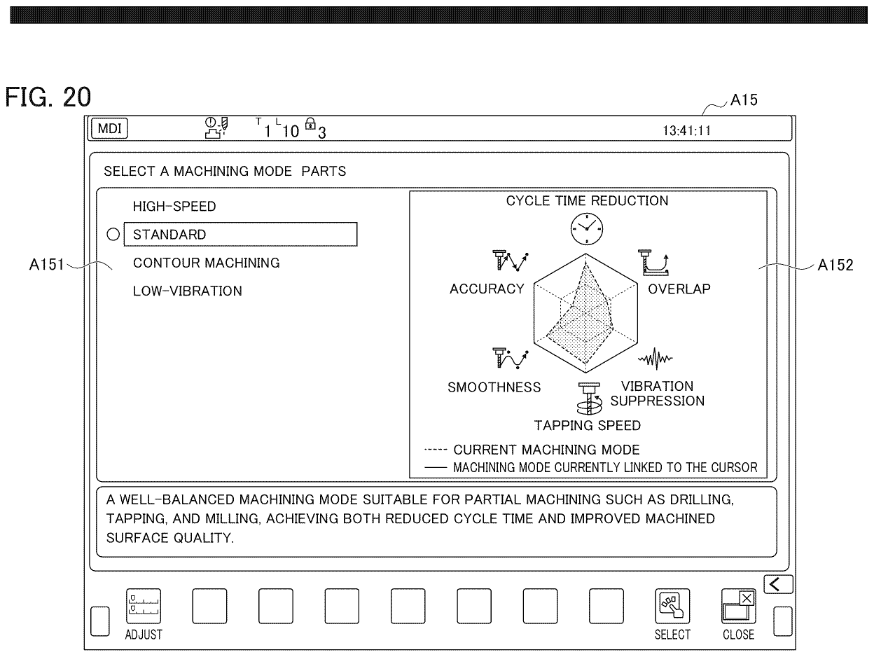

The lists of the machining modes are sortable based on each of the indicators. FIG. 19 shows an example of such a sorting function. FIG. 20 shows an example of a list of machining modes sorted using the sorting function. A display screen A14 shown in FIG. 19 includes an image A141 that is displayed on the left side of the screen and shows the currently selected machining mode, an image A142 that is displayed on the right side of the screen and shows characteristics of the machining mode using a radar chart, and an image A143 that is displayed on the lower side of the screen and shows a software key representing the sorting function for sorting the list of machining modes.

A display screen A15 shown in FIG. 20 includes an image A151 that is displayed on the left side of the screen and shows the currently selected machining mode, and an image A152 that is displayed on the right side of the screen and shows characteristics of the machining mode using a radar chart.

As shown in FIG. 19, upon the image A143 being selected, the display control unit 15 replaces the image A143 representing the sorting function with an image A144 representing an initialization function, an image A145 representing a sorting function for sorting based on the indicator “Cycle time reduction”, an image A146 representing a sorting function for sorting based on the indicator “High quality”, and an image A147 representing a sorting function for sorting based on the indicator “Accuracy”. Then, upon the image A146 being selected, the machining mode adjustment unit 14 sorts the list of machining modes in the order of suitability for the indicator “Cycle time reduction”, and the display control unit 15 displays the image A151 that shows the sorted list of machining modes.

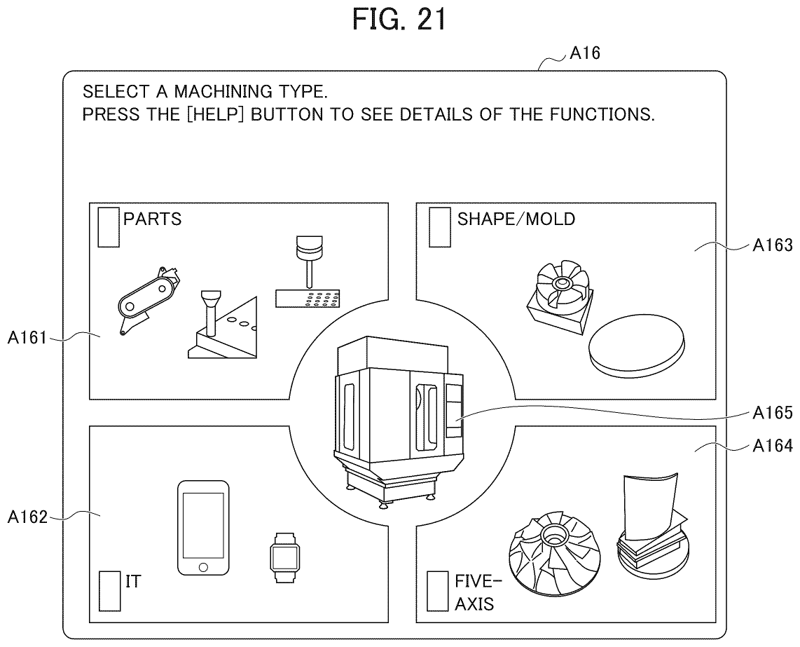

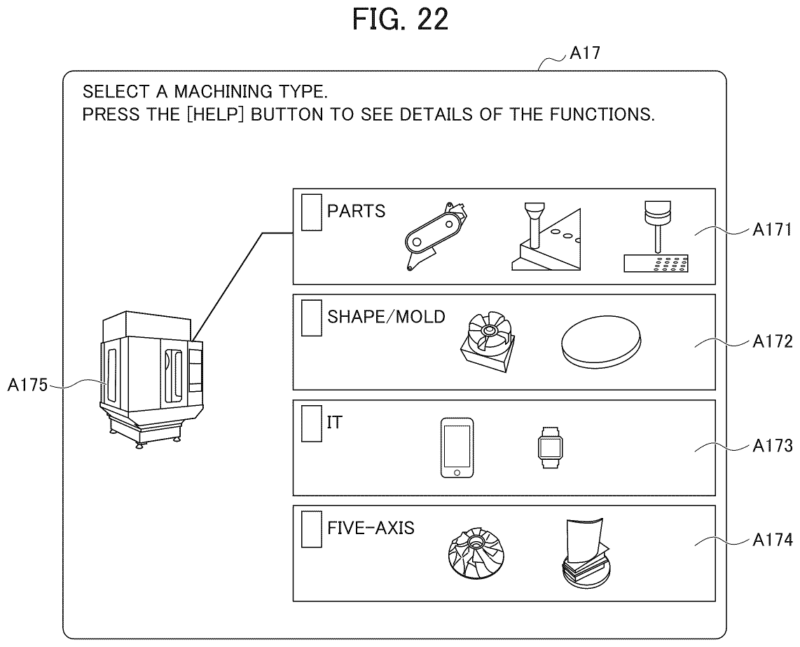

Furthermore, the machining type images may include an image representing the machine tool 2 and an image implying a change in settings in the machine tool 2. FIGS. 21 and 22 show examples of machining type images. A machining type image A16 shown in FIG. 21 includes an image A161 that is located in an upper left area of the screen and shows the machining type “Parts”, an image A162 that is located in a lower left area of the screen and shows the machining type “IT”, an image A163 that is located in an upper right area of the screen and shows the machining type “Shape/Mold”, an image A164 that is located in a lower right area of the screen and shows the machining type “Five-axis”, and an image A165 that shows a photograph of the external appearance of the machine tool 2.

A machining type image A17 shown in FIG. 22 includes an image A171 that shows the machining type “Parts”, an image A172 that shows the machining type “IT”, an image A173 that shows the machining type “Shape/Mold”, an image A174 that shows the machining type “Five-axis”, and an image A175 that shows a photograph of the external appearance of the machine tool 2. The machining type image A16 and the machining type image A17 shown in FIG. 21 and FIG. 22 each include an image that shows a photograph of the actual machine tool 2 and images of machined products subjected to machining of the respective machining types, implying, as a whole, a change in settings in the machine tool 2.

According to the present embodiment, the numerical control device 1 has at least two machining modes each defining a combination of parameters of at least one of an acceleration/deceleration function, a servo function, or a compensation function required for machining with the machine tool 2, the numerical control device including the display control unit 15 that displays information pertaining to the machining modes on the display device 16. The machining modes are classified into one or more machining types based on machining. The display control unit 15 displays one or more machining type images that are used to select one of the one or more machining types, and upon one of the one or more machining types being selected, displays an image showing any of the machining modes set for the selected machining type. The numerical control device 1 having such a configuration makes it possible to easily select a machining mode for the machine tool 2 regardless of the user's skill level, thereby facilitating efficient machining. The user of the numerical control device 1 can easily select a machining mode suitable for the machining object.

The machining types include Parts, Shape/Mold, IT, and Four-axis or Five-axis. The numerical control device 1 having such a configuration makes it possible for each user to easily select a machining mode by combining machining mode characteristics and machining types.

The one or more machining type images include a photograph of a machined product or a graphic related to a machining method employed. This configuration allows the user of the numerical control device 1 to intuitively determine a machining type corresponding to the machining.

The one or more machining type images are assigned one or more of alphanumeric characters and/or symbols, icons, or colors for identifying the machining types. The numerical control device 1 having such a configuration makes it possible to easily identify the machining types without the need to read the names of the machining types, allowing the user to intuitively determine a machining type corresponding to the machining.

The colors assigned for identifying the machining types are distinguishable by individuals with color vision deficiency. This configuration allows the user of the numerical control device 1 to distinguish the colors assigned to the respective machining types and easily discern the machining types, even if the user has color vision deficiency.

The machining modes may have names that are consistent across the different machining types. Since the names of the machining modes classified into the different machining types are common and consistent across the different machining types, this configuration enables the numerical control device 1 to assist the user in understanding the machining modes. The machining modes may have names that indicate machining content. This configuration enables the numerical control device 1 to assist the user in understanding the machining modes.

The display control unit 15 displays a brief description of the machining types or the machining modes, or a detailed description of the machining types or the machining modes, depending on an operation received from the user. This configuration enables the numerical control device 1 to provide the user with a description of the machining types or the machining modes.

The display control unit 15 switches between displaying and hiding images related to the machining types or the machining modes depending on the state of the machine tool 2. This configuration allows the user of the numerical control device 1 to select a machining type without seeing unnecessary information.

The display control unit 15 displays a list of parameters, a comparison table of parameters, or a chart related to parameters along with a list of the machining modes. This configuration allows the user of the numerical control device 1 to compare and check parameters while referring to the list of machining modes.

The display control unit 15 displays the machining type images and lists of the machining modes on the same screen. This configuration allows the user of the numerical control device 1 to check and select both a machining type and a machining mode on the same screen.

The lists of the machining modes are sortable based on each of the indicators. This configuration allows the user of the numerical control device 1 to sort the machining modes based on an indicator such as Cycle time reduction, Smoothness, or Accuracy.

The machining type images include an image representing the machine tool 2 and an image implying a change in settings in the machine tool 2. This configuration allows the user of the numerical control device 1 to intuitively determine a machining type corresponding to the machining.

Embodiments of the present invention have been described above. The numerical control device 1 described above can be implemented by hardware, software, or a combination thereof. A control method that is carried out by the numerical control device 1 described above can also be implemented by hardware, software, or a combination thereof. Being implemented by software herein means being implemented through a computer reading and executing a program.

The program can be supplied to the computer by being stored on any of various types of non-transitory computer readable media. The non-transitory computer readable media include various types of tangible storage media. Examples of the non-transitory computer readable media include magnetic storage media (such as hard disk drives), magneto-optical storage media (such as magneto-optical disks), compact disc read only memory (CD-ROM), compact disc recordable (CD-R), compact disc rewritable (CD-R/W), and semiconductor memory (such as mask ROM, programmable ROM (PROM), erasable PROM (EPROM), flash ROM, and random access memory (RAM)).

Although the present disclosure has been described in detail above, the present disclosure is not limited to the foregoing individual embodiments. Various changes, such as additions, substitutions, alterations, and partial omissions, may be made to the foregoing embodiments to the extent that such changes do not depart from the gist of the present disclosure, or to the extent that such changes do not depart from the gist of the present disclosure that is derived from the appended claims or the equivalents thereof. Any of the foregoing embodiments can be implemented in combination with each other. For example, the order of operations and the order of processes mentioned in the foregoing embodiments are merely examples, and the present disclosure is not limited thereto. The same applies to numerical values or mathematical formulas that are used in the description of the foregoing embodiments, if any.

The following further discloses additional remarks regarding the foregoing embodiments and modification examples thereof.

### Additional Remark 1

A machining information display device (1) having at least two machining modes each defining a combination of parameters of at least one of an acceleration/deceleration function, a servo function, or a compensation function required for machining with a machine tool, the machining information display device including a display control unit (15) that displays information pertaining to the machining modes on a display device, wherein
the machining modes are classified into one or more machining types based on machining, and
the display control unit
displays one or more machining type images that are used to select one of the one or more machining types, and
upon one of the one or more machining types being selected, displays an image showing any of the machining modes set for the selected machining type.

### Additional Remark 2

The machining information display device according to Additional Remark 1, wherein the machining types include Parts, Shape/Mold, IT, and Four-axis or Five-axis.

### Additional Remark 3

The machining information display device according to Additional Remark 1 or 2, wherein the one or more machining type images include a photograph of a machined product or a graphic related to a machining method employed.

### Additional Remark 4

The machining information display device according to Additional Remark 1 or 2, wherein the one or more machining type images are each assigned one or more of: an alphanumeric character and/or a symbol, an icon, or a color for identifying the one or more machining types.

### Additional Remark 5

The machining information display device according to Additional Remark 1 or 2, wherein a color assigned for identifying the one or more machining types is distinguishable by individuals with color vision deficiency.

### Additional Remark 6

The machining information display device according to Additional Remark 1 or 2, wherein the machining modes have names that are consistent across the different machining types.

### Additional Remark 7

The machining information display device according to Additional Remark 1 or 2, wherein the machining modes have names that indicate machining content.

### Additional Remark 8

The machining information display device according to Additional Remark 1 or 2, wherein the display control unit displays a brief description of the one or more machining types or the machining modes, or a detailed description of the one or more machining types or the machining modes, depending on an operation received from a user.

### Additional Remark 9

The machining information display device according to Additional Remark 1 or 2, wherein the display control unit switches between displaying and hiding one or more images related to the one or more machining types or images related to the machining modes depending on the state of the machine tool.

### Additional Remark 10

The machining information display device according to Additional Remark 1 or 2, wherein the display control unit displays a list of parameters, a comparison table of parameters, or a chart related to parameters along with a list of the machining modes.

### Additional Remark 11

The machining information display device according to Additional Remark 1 or 2, wherein the display control unit displays the machining type images and a list of the machining modes on the same screen.

### Additional Remark 12

The machining information display device according to Additional Remark 1 or 2, wherein a list of the machining modes is sortable based on each of a plurality of indicators related to the machining.

### Additional Remark 13

The machining information display device according to Additional Remark 1 or 2, wherein the one or more machining type images include an image representing the machine tool and an image implying a change in settings in the machine tool.
1: Numerical control device
2: Machine tool
11: Input device
12: Input reception unit
13: Parameter setting unit
14: Machining mode adjustment unit
15: Display control unit
16: Display device

1. A machining information display device having at least two machining modes each defining a combination of parameters of at least one of an acceleration/deceleration function, a servo function, or a compensation function required for machining with a machine tool, the machining information display device comprising a display control unit that displays information pertaining to the machining modes on a display device, wherein
the machining modes are classified into one or more machining types based on machining, and
the display control unit
displays one or more machining type images that are used to select one of the one or more machining types, and
upon one of the one or more machining types being selected, displays an image showing any of the machining modes set for the selected machining type.

2. The machining information display device according to claim 1, wherein the machining types include Parts, Shape/Mold, IT, and Four-axis or Five-axis.

3. The machining information display device according to claim 1, wherein the one or more machining type images include a photograph of a machined product or a graphic related to a machining method employed.

4. The machining information display device according to claim 1, wherein the one or more machining type images are each assigned one or more of: an alphanumeric character and/or a symbol, an icon, or a color for identifying the one or more machining types.

5. The machining information display device according to claim 1, wherein a color assigned for identifying the one or more machining types is distinguishable by individuals with color vision deficiency.

6. The machining information display device according to claim 1, wherein the machining modes have names that are consistent across the different machining types.

7. The machining information display device according to claim 1, wherein the machining modes have names that indicate machining content.

8. The machining information display device according to claim 1, wherein the display control unit displays a brief description of the one or more machining types or the machining modes, or a detailed description of the one or more machining types or the machining modes, depending on an operation received from a user.

9. The machining information display device according to claim 1, wherein the display control unit switches between displaying and hiding one or more images related to the one or more machining types or images related to the machining modes depending on the state of the machine tool.

10. The machining information display device according to claim 1, wherein the display control unit displays a list of parameters, a comparison table of parameters, or a chart related to parameters along with a list of the machining modes.

11. The machining information display device according to claim 1, wherein the display control unit displays the one or more machining type images and a list of the machining modes on the same screen.

12. The machining information display device according to claim 1, wherein a list of the machining modes is sortable based on each of a plurality of indicators related to the machining.

13. The machining information display device according to claim 1, wherein the one or more machining type images include an image representing the machine tool and an image implying a change in settings in the machine tool.
